(19) United States
(12) Patent Application Publication
(10) Pub. No.: US 2007/0175596 A1
(43) Pub. Date: Aug. 2, 2007

(54) Structure of a roller blind

(76) Inventor: Gow-Ten Chien, Taipei (TW)

Correspondence Address: Gow-Ten CHIEN, P. O. Box No. 6-57, Junghe, Taipei, 235, TW

(21) Appl. No.: 11/341,390

(22) Filed: Jan. 30, 2006

(51) Int. Cl. E06B 9/08

(52) U.S. Cl. 160/121.1

(57) ABSTRACT

A structure of a roller blind is primarily composed of a cloth which contains light-pervious sides and opaque sides aligned in an equal spacing, and on which is printed with various patterns. After continuously bending the cloth vertically and horizontally, the light-pervious sides of the vertical part are attached to two transparent cloths to constitute a roller blind. When the transparent cloths are suspended evenly, the horizontal part of cloth is in a horizontal shape, so as to enable light to penetrate from each transparent cloth and the vertical part of cloth. On the other hand, when one of the transparent cloths is pulled up, the horizontal part will be tilted, so as to constitute an effect of shading. In addition, a sense of beauty of the blind will be increased by the printed patterns.

### BACKGROUND OF THE INVENTION

(a) Field of the Invention

The present invention relates to an improved structure of a roller blind, and more particularly to a structure of roller blind that can be adjusted to a status of shading or non-shading, and can manifest different patterns.

(b) Description of the Prior Art

Referring to FIG. 1, an ordinary roller blind for shading sun comprises a roller 1 whose interior is provided with a cloth curtain 11. The cloth curtain 11 is normally retracted into the roller 1, and is pulled down as a shade when sun is shining in a room. As this kind of roller blind can only provide a function of choosing between light-pervious and light shading, and cannot adjust an angle of shading through the cloth curtain 11 and is not provided with a better decoration effect, therefore it is lack of practicability.

### SUMMARY OF THE INVENTION

The primary object of the present invention is to provide an improved structure of a roller blind such that an effect of light-pervious, light shading or adjustment of angle of shading can be constituted upon using the roller blind, thereby increasing a practicability of the roller blind.

The aforementioned structure is provided with a piece of cloth wherein light-pervious sides and opaque sides are aligned with an equal spacing. After continuously bending the cloth vertically and horizontally, the light-pervious sides constitute a vertical part, whereas the opaque sides constitute a horizontal part, in order to attach each vertical part of the cloth to two transparent cloths for forming a roller blind. When the two transparent cloths are suspended evenly, light can penetrate from the transparent cloths and the vertical part of cloth due to a horizontal shape of the horizontal part of cloth. Whereas when any one of the transparent cloths is pulled up, the vertical part of cloth will be tilted to constitute an adjustment of an angle of shading, thereby achieving an effect of partial shading.

In the aforementioned structure of roller blind, various patterns are printed on the cloth, so as to manifest the patterns to increase a sense of beauty in vision to the roller blind, upon overlapping the cloth and the transparent cloths.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional roller blind.

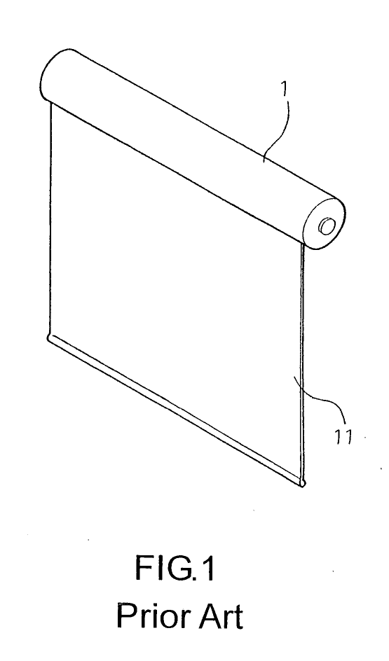

FIG. 2 shows a perspective view of the present invention.

FIG. 3 shows another perspective view of the present invention.

FIG. 4 shows a perspective view of compartments of the present invention.

FIG. 5 shows a schematic view of an implementation of the present invention.

FIG. 6 shows a schematic view of another implementation of the present invention.

### DETAILED DESCRIPTION OF THE PREFERRED EMBODIMENTS

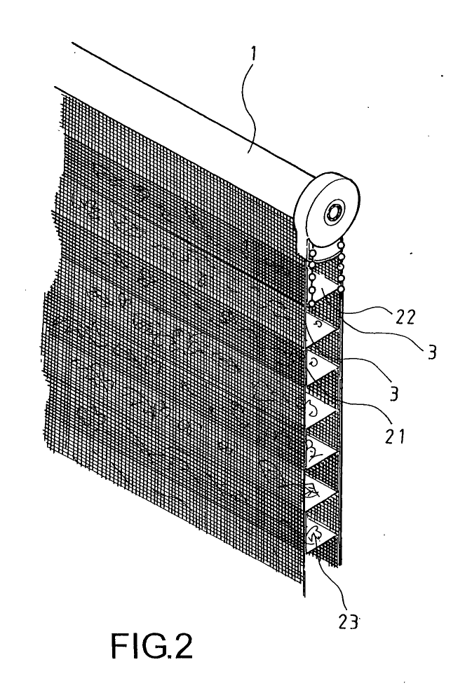

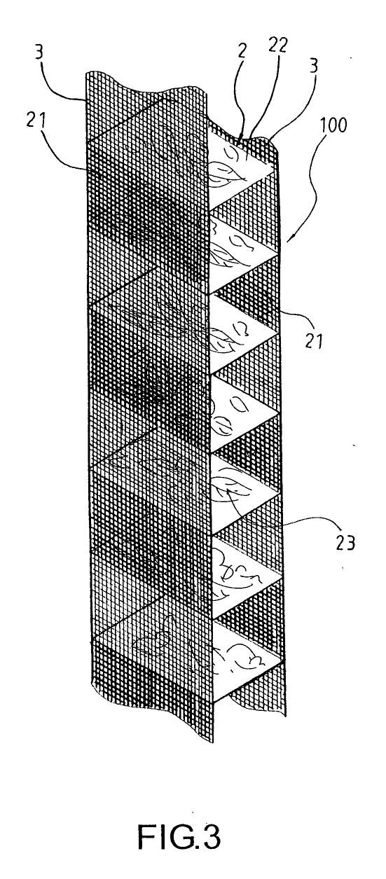

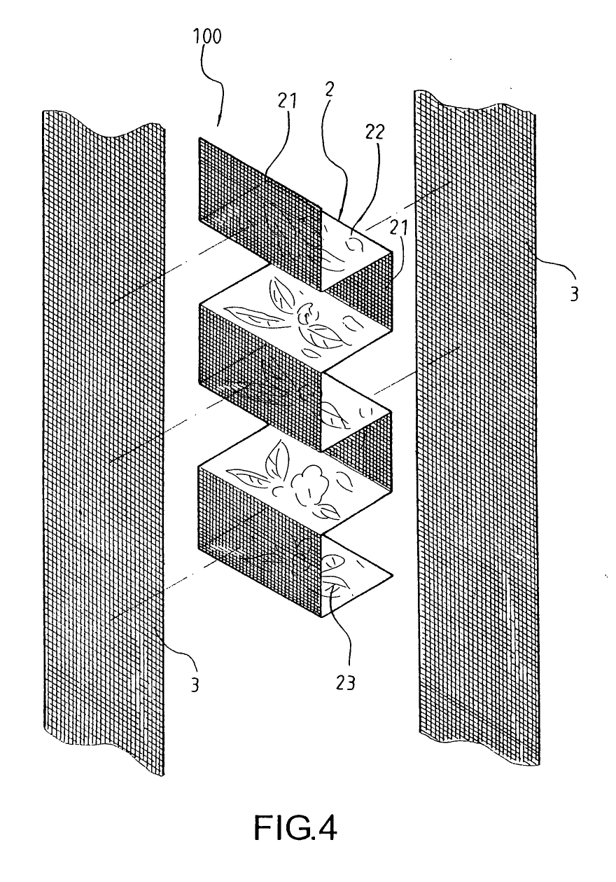

Referring to FIG. 2, FIG. 3, and FIG. 4, the present invention comprises primarily a cloth 2 containing light-pervious sides 21 and opaque sides 22 aligned in an equal spacing, such that the light-pervious sides 21 constitute a vertical part and the opaque sides 22 constitute a horizontal part, after continuously bending the cloth 2 vertically and horizontally. The light-pervious sides 21 of the vertical part of cloth 2 are attached to two transparent cloths 3 to form a roller blind 100 in a grid shape, such that the two transparent cloths are suspended evenly, upon using the roller blind 100, in order to constitute a horizontal shape to the light-pervious sides 22 of the horizontal part for allowing light to penetrate from the transparent cloths 3 and the light-pervious sides 21 of cloth 2. On the other hand, when any one of the transparent cloths 3 is pulled up to tilt the opaque sides 22, an effect of shading is constituted by the shading of the opaque sides 22, or an effect of partial shading is achieved by an adjustment of an angle of shading.

Various patterns are printed on the aforementioned cloth 2, so as to manifest the clear patterns to increase a sense of beauty in vision to the roller blind, when the cloth 2 and the transparent cloths 3 are overlapped during an action of light shading.

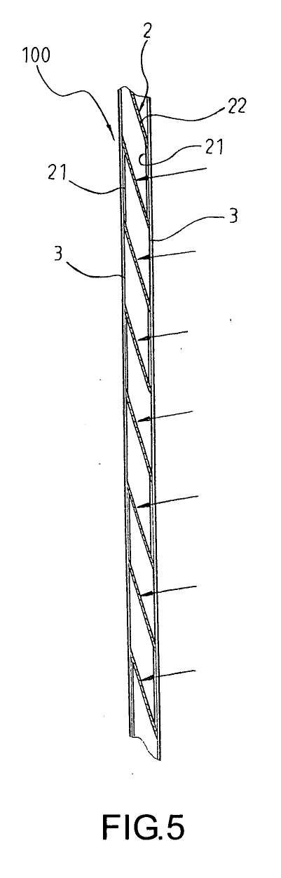

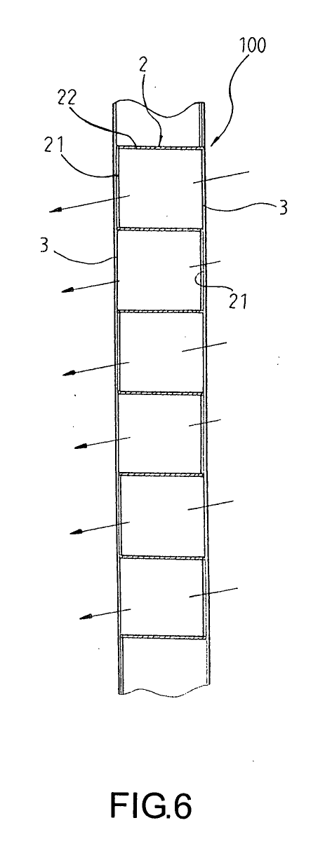

Referring to FIG. 5 and FIG. 6, when using the present invention, one of the transparent cloths 3 is pulled up after suspending the roller blind 100, while the opaque sides 22 of the horizontal part of cloth 2 are tilted due to a pull-up of one end from an imbalance of the two transparent cloths 3. Accordingly, light can be shaded by the opaque sides 22, thereby achieving an effect of light-shading. On the other hand, as shown in FIG. 5, when it is required to allow light to penetrate or partially penetrate, any one of the transparent cloths 3 is pulled down to suspend the two transparent cloths evenly, or an tilt of the opaque sides 22 of cloth 2 is reduced, so as to enable light to penetrate from the transparent cloths 3, and the light-pervious sides 21 of cloth, thereby achieving an effect of light-pervious or partial light-pervious.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A structure of a roller blind including primarily a cloth which contains light-pervious sides and opaque sides aligned in an equal spacing, such that the light-pervious sides constitute a vertical part and the opaque sides constitute a horizontal part after continuously bending the cloth vertically and horizontally; a roller blind being constituted by attaching each light-pervious side of the vertical part of cloth to two transparent cloths; when using the roller blind, the two transparent cloths being suspended evenly so as to constitute a horizontal shape to the opaque sides of cloth for forming a light-pervious effect, or any one of the transparent cloths being pulled up to tilt the horizontal part for achieving an effect of shading or partial shading.

2. The structure of a roller blind according to claim 1, wherein various patterns are printed on the cloth, so as to manifest the patterns to increase a sense of beauty in vision to the roller blind in shading.
